(19) United States
(12) Patent Application Publication
(10) Pub. No.: US 2003/0121709 A1
(43) Pub. Date: Jul. 3, 2003

(54) Safety system

(76) Inventor: Reidar Lyshaug, Roknas (NO)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/169,072

(22) PCT Filed: Jan. 4, 2001
(86) PCT No.: PCT/SE01/00009

(30) Foreign Application Priority Data
Jan. 5, 2000 (SE) 0000021-6

(51) Int. Cl. B60R 21/00

(52) U.S. Cl. 180/271

(57) ABSTRACT

The invention relates to a safety system 10 for motor-driven vehicles 12 comprising at least one door 14. The system 10 comprises a movement detector 161, . . . , 16N at each door 14 to detect movement within a predetermined area 181, . . . , 18N near said door 14 and/or a movement detector 20 at the rear of the vehicle 12 to detect movement within a predetermined area 22 behind the vehicle 12, and wherein each movement detector 161, . . . , 16N, 20 is also connected to an indicator 261, . . . , 26N, 26B arranged in conjunction with the driver's seat 24 in the vehicle 12 in order to attract the attention of the driver upon detection of movement within said area/areas 181, . . . , 18N, 22.

### TECHNICAL FIELD

The present invention relates to a safety system for motor-driven vehicles comprising at least one door.

### BACKGROUND ART

A serious problem encountered with public transport and other types of passenger vehicles is the occurrence of accidents during entering and alighting from the vehicle. In recent years, for instance, a number of bus accidents have occurred where the driver did not observe a passenger alighting from the bus and where the passenger became caught in the closed door. The vehicle may also reverse onto a passenger or other person.

Document AU-A-1,246,997 relates to a safety system for the doors of trains, buses and other vehicles. The system comprises sensors to detect the presence of a person or object against the closing edge of the door, and a programmable logic control unit or microprocessor which, upon receiving the signal from the sensor, feeds signals to an interface connected to the electrical system of the vehicle and to the pneumatic control of the opening and closing mechanism for the doors. The sensor comprises a deformable, resilient, protective strip along the closing edge of the door, and a pulsed, infrared, photo-electric emitter and receiver arranged so that deformation of the protective strip disconnects the infrared beam directed along the inside of the protective strip.

Document DE-A1-3150693 shows a safety system for a bus door, for instance. The safety system comprises a force measuring device and a position transducer for the door. The signals from the force measuring device and position transducer influence, via an amplifier, the electronics, and a solenoid valve, the pneumatic cylinder which in turn influences opening and closing of the door.

Document U.S. Pat. No. 4,981,084 shows a safety system for bus doors, for instance. The system comprises position sensors that indicate whether the door panels are closed or not and report when the door panels are closed. The system also comprises movement sensors for the door panels, which sensors are coordinated with movement drive units in order to determine movement of the door relevant movement detector detects movement within said areas, and ceasing to emit audible signals with a predetermined time delay after the relevant movement detector no longer detects movement within said areas.

An additional advantage in this connection is obtained if said time delay is approximately 3-4 seconds.

In this connection it is also advantageous for the movement detectors at the doors to be arranged above the doors and for said areas at ground level to comprise at least the width of the door and approximately 1-2 metre out from the vehicle.

Yet another advantage is obtained if the system is powered via the electrical system of the vehicle, and if the safety system is activated when the vehicle is started and the indicator(s) is/are activated for a predetermined period of time to check that the system is functioning.

The invention will now be described in more detail in the form of embodiments, with reference to the accompanying drawings.

### BRIEF DESCRIPTION OF THE DRAWINGS

FIG. 1 shows schematically a safety system for motor-driven vehicles in accordance with the present invention;

FIG. 2 shows a side view of part of the safety system in accordance with the present invention, shown in FIG. 1;

FIG. 3 shows a view from the front of a part of the safety system in accordance with the present invention, shown in FIG. 1;

FIG. 4 shows a view from above of the part of the safety system in accordance with the present invention shown in FIGS. 2 and 3; and

FIG. 5 shows schematically a rear-view mirror included in the safety system in accordance with the present invention, shown in FIG. 1.

### DETAILED DESCRIPTION OF EMBODIMENTS OF THE PRESENT INVENTION

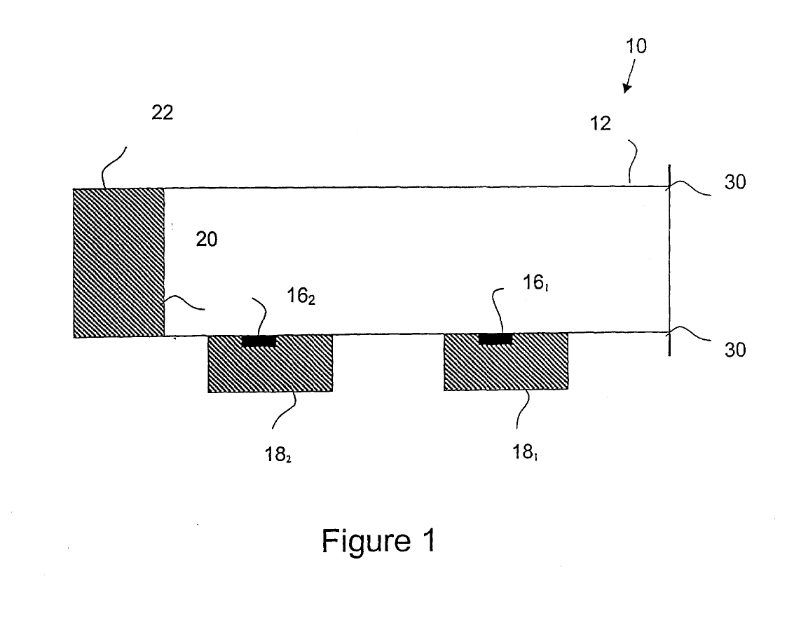

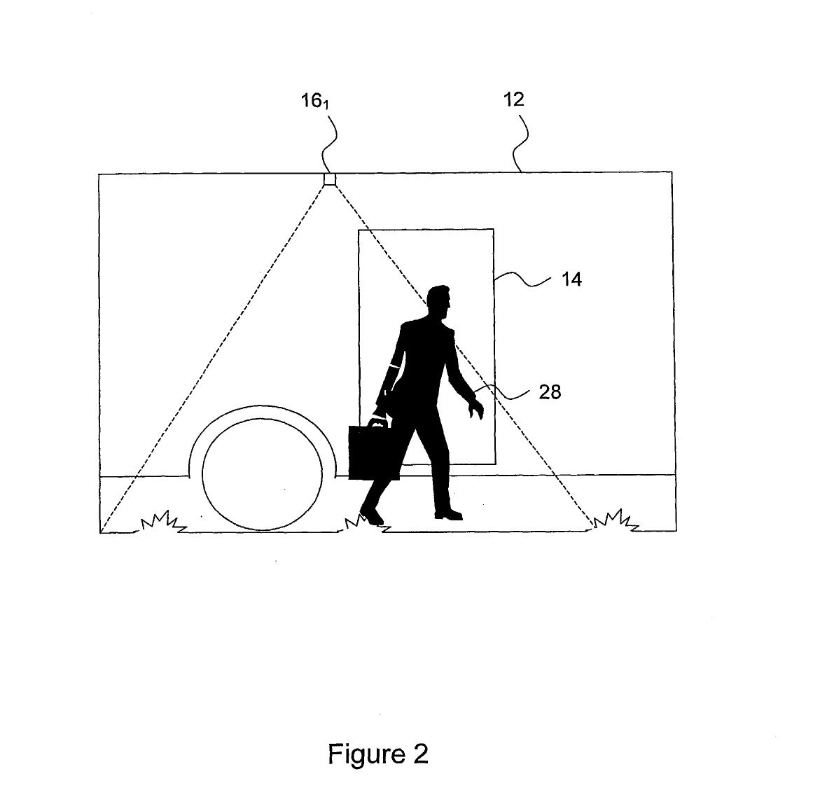

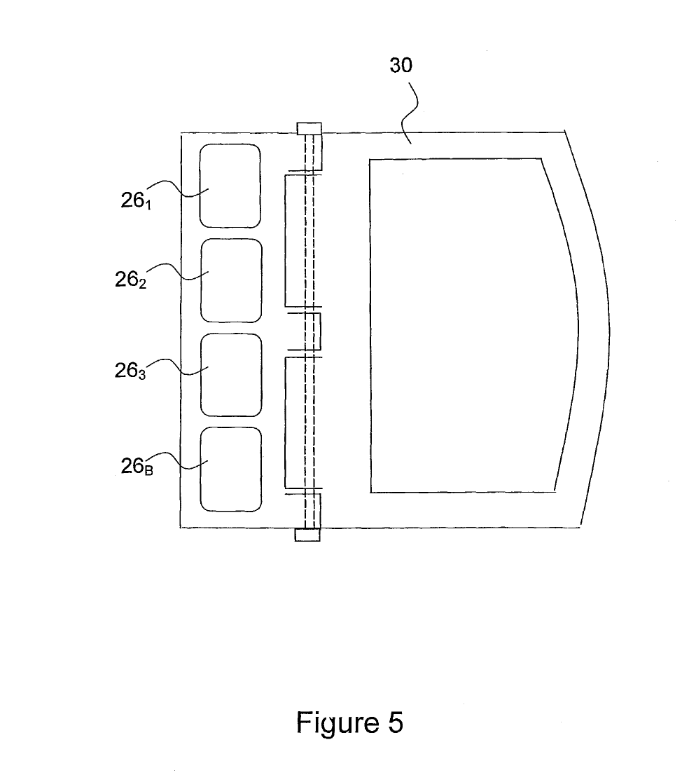

FIG. 1 shows schematically a safety system for motor-driven vehicles 12 in accordance with the present invention. In the case illustrated in FIG. 1 the motor-driven vehicle 12 is a bus 12, but may of course be a tram, an underground train carriage, a private car or a lorry. The safety system 10 comprises a movement detector 16₁, 16₂ at each door 14 (see FIG. 2, for instance) to detect movement within a predetermined area 18₁, 18₂. The safety system 10 illustrated in FIG. 1 also comprises a movement detector 20 at the rear of the bus 12 to detect movement within a predetermined area 22 behind the bus 12. The safety system 10 may naturally comprise as many movement detectors 16₁, . . . , 16_{N} as the number of doors N pertaining to the vehicle, as well as a movement detector at the rear of the vehicle, where N is an integer. Each movement detector 16₁, 16₂, 20 is connected to an indicator 26₁, 26₂, 26_{B} (see FIG. 5) in conjunction with the driver's seat 24 in the bus 12 in order to attract the attention of the driver upon detection of movement within said areas 18₁, 18₂, 22. An advantageous embodiment of the present invention is obtained if the movement detectors 16₁, 16₂, 20 consist of IR movement detectors. In accordance with another advantageous embodiment, the movement detectors 16₁, 16₂, 20 are of laser type.

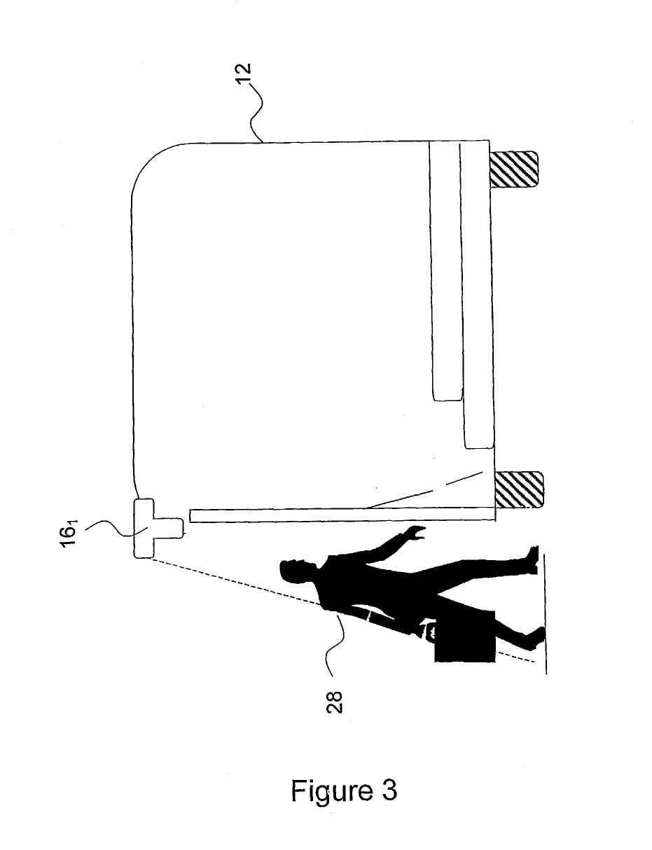

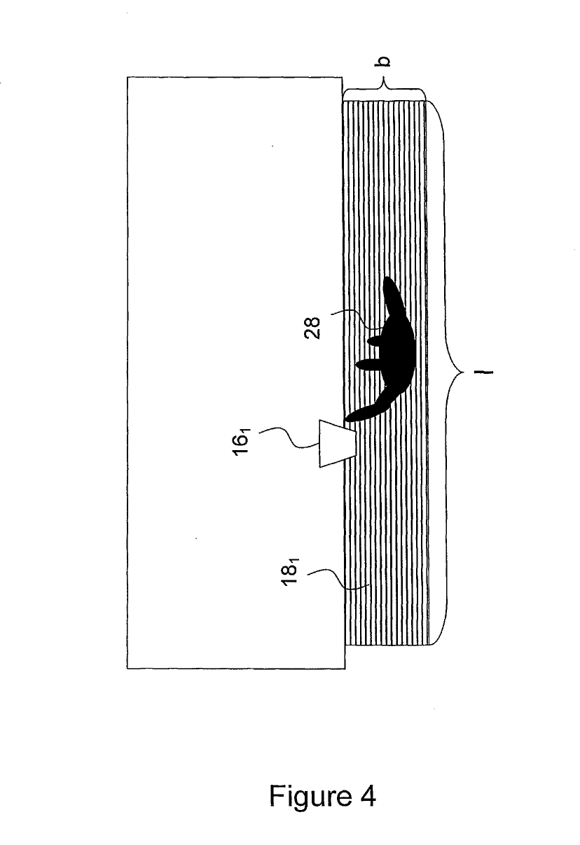

FIGS. 2-4 illustrate various views of part of the safety system 10 in accordance with the invention, shown in FIG. 1. Here a passenger 28 is seen about to enter a bus 12 via a door 14. It is also clear from these figures how the movement detector 16₁, may be placed above the door 14. Naturally the movement detector 16₁ may be placed differently, e.g. centrally above the opening of the door 14. It is also clear that the passenger 28 is within the area 18₁, covered by the movement detector 16₁. As can be seen particularly clearly in FIG. 4, this area 18₁ has a breadth, b, and a length, I, on the ground. In this case the driver's attention is attracted via the indicator 26₁. The breadth, b, of the area, e.g. 18₁, is preferably 1-2 metre out from the vehicle 12. The length, I, of the area 18₁ is at least the width of the door 14. However, as is clear from FIGS. 2-4, the length, I, may be considerably greater, about 3 times the width of the door 14.

FIG. 5 shows schematically a rear-view mirror 30 forming a part of the safety system 10 in accordance with the present invention as shown in FIG. 1. In this embodiment the safety system 10 comprises four indicators 26₁, 26₂, 26₃, 26_{B}. Each indicator 26₁, 26₂, 26₃, 26_{B} may consist, for example, of a lamp, each lamp emitting a different-coloured light. When movement is detected by the detector 16₁, for instance, in the area 18₁, the lamp 26₁ will light up. This attracts the attention of the driver. The placing of the lamps also makes it easier for the driver to see them. The lamps 26₁, 26₂, 26₃, 26_{B} are extinguished with a predetermined time delay after the relevant movement detector no longer detects movement within said areas. This time delay may be approximately 3-4 seconds, for instance.

In accordance with another embodiment the indicator is instead placed in the driver's place 24 (see FIG. 1). In this embodiment each indicator may alternatively consist of a sound alarm, each sound alarm emitting a characteristic audible signal when a particular movement detector detects movement within said areas, and ceasing to emit the audible signal with a predetermined time delay after the movement detector no longer detects movement within said areas.

The safety system 10 in accordance with the invention may be powered, for instance, via the electrical system of the vehicle 12 (not shown). When the vehicle 12 is started the safety system 10 is activated for a predetermined period of time in order to check that the system 10 is functioning.

The embodiments of the safety system in accordance with the present invention shown in the drawings do not constitute any limitation of the invention, its scope of protection being defined in the appended claims.

1. A safety system (10) for motor-driven vehicles (12) comprising at least one door (14), characterized in that the system (10) comprises a movement detector (16₁, . . . , 16_{N}) at each door (14) to detect movement within a predetermined area (18₁, . . . , 18_{N}) near said door (14) and/or a movement detector (20) at the rear of the vehicle (12) to detect movement within a predetermined area (22) behind the vehicle (12), and in that each movement detector (16₁, . . . , 16_{N}, 20) is connected to an indicator (26₁, . . . , 26_{N}, 26_{B}) in conjunction with the rear-view mirror (30) of the vehicle (12) in order to attract the attention of the driver upon detection of movement within said area/areas (18₁, . . . , 18_{N}, 22) to enable the driver alone to reach a decision.

2. A safety system (10) for motor-driven vehicles (12) as claimed in claim 1, characterized in that each movement detector (16₁, . . . , 16_{N}, 20) consists of an IR movement detector.

3. A safety system (10) for motor-driven vehicles (12) as claimed in claim 1, characterized in that each movement detector (16₁, . . . , 16_{N}, 20) consists of a movement detector of laser type.

4. A safety system (10) for motor-driven vehicles (12) as claimed in any one of claims 1-3, characterized in that each indicator (26₁, . . . , 26_{N}, 26_{B}) consists of a lamp, each lamp emitting a different-coloured light.

5. A safety system (10) for motor-driven vehicles (12) as claimed in claim 4, characterized in that the lamps are fitted close to or in the rear-view mirror (30), and in that each lamp lights up when the relevant movement detector (16₁, . . . , 16_{N}, 20) detects movement within said areas (18₁, . . . , 18_{N}, 22), and is extinguished with a predetermined time delay after the relevant movement detector (16₁, . . . , 16_{N}, 20) no longer detects movement within said areas (18₁, . . . , 18_{N}, 22).

6. A safety system (10) for motor-driven vehicles (12) as claimed in any one of claims 1-3, characterized in that each indicator (26₁, . . . , 26_{N}, 26_{B}) consists of a sound alarm, each sound alarm emitting an audible signal when the relevant movement detector (16₁, . . . , 16_{N}, 20) detects movement within said areas (18₁, . . . , 18_{N}, 22), and ceasing to emit audible signals with a predetermined time delay after the relevant movement detector (16₁, . . . , 16_{N}, 20) no longer detects movement within said areas (18₁, . . . , 18_{N}, 22).

7. A safety system (10) for motor-driven vehicles (12) as claimed in claim 5 or claim 6, characterized in that said time delay is approximately 3-4 seconds.

8. A safety system (10) for motor-driven vehicles (12) as claimed in any one of claims 1-7, characterized in that the movement detectors (16₁, . . . , 16_{N}, 20) at the doors (14) are arranged above the doors (14), and in that said areas (18₁, . . . , 18_{N}), at ground level comprise at least the width (I) of the door (14) and approximately 1-2 metre out from the vehicle.

9. A safety system (10) for motor-driven vehicles (12) as claimed in any one of claims 1-8, characterized in that the system (10) is powered via the electrical system of the vehicle, and in that the safety system (10) is activated when the vehicle (12) is started and the indicator(s) (26₁, . . . , 26_{N}, 26_{B}) is/are activated for a predetermined period of time to check that the system (10) is functioning.
